(19) United States
(12) Patent Application Publication
(10) Pub. No.: US 2021/0070289 A1
(43) Pub. Date: Mar. 11, 2021

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Kaijiang Yu, Wako-shi (JP)

(21) Appl. No.: 17/015,107

(22) Filed: Sep. 9, 2020

(30) Foreign Application Priority Data
Sep. 11, 2019 (JP) 2019-165385

(51) Int. Cl. B60W 30/095; B60W 30/18; B60W 40/04; B60W 60/00; G06K 9/00

(52) U.S. Cl. CPC B60W 30/0956; B60W 30/18159; B60W 40/04; B60W 2554/4049; G06K 9/00825; G06K 9/00798; B60W 60/0016

(57) ABSTRACT

A vehicle control device includes a recognition unit configured to, when a first vehicle enters a circular intersection, recognize a traveling trajectory after a second vehicle that has entered the circular intersection enters the circular intersection; an action estimation unit configured to estimate an action until the second vehicle exits the circular intersection; and a trajectory generation unit configured to generate a traveling trajectory including a velocity component for the first vehicle to enter the circular intersection on the basis of an estimation result of an action of the second vehicle estimated by the action estimation unit.

### CROSS-REFERENCE TO RELATED APPLICATION

Priority is claimed on Japanese Patent Application No. 2019-165385, filed Sep. 11, 2019, the content of which is incorporated herein by reference.

### BACKGROUND OF THE INVENTION

### Field of the Invention

The present invention relates to a vehicle control device, a vehicle control method, and a storage medium.

### Description of Related Art

In recent years, installation of circular intersections (roundabouts) has become widespread. In connection with this, a technology for detecting a rotation angle indicating a position of a vehicle in a circular intersection is known (for example, refer to Japanese Unexamined Patent Application, First Publication No. 2019-45341).

### SUMMARY OF THE INVENTION

However, in the related art, the studies regarding actions of other vehicles that are traveling in a circular intersection, and particularly, estimating which exit other vehicles will take have been insufficient. Therefore, it may not be possible to travel in a circular intersection smoothly and autonomously.

Aspects of the present invention have been made in view of such circumstances, and one object is to provide a vehicle control device, a vehicle control method, and a storage medium which allow a vehicle to travel in a circular intersection smoothly and autonomously.

In order to solve the above problems and achieve the object, the present invention provides the following aspects.

(1): A vehicle control device according to an aspect of the present invention includes a recognition unit configured to, when a first vehicle enters a circular intersection, recognize a traveling trajectory after a second vehicle that has entered the circular intersection enters the circular intersection; an action estimation unit configured to estimate an action until the second vehicle exits the circular intersection; and a trajectory generation unit configured to generate a traveling trajectory including a velocity component for the first vehicle to enter the circular intersection on the basis of an estimation result of an action of the second vehicle estimated by the action estimation unit.
(2): In the above aspect (1), the trajectory generation unit may refer to an estimation result of the action estimation unit and determines whether the second vehicle and the first vehicle interfere with each other, and when it is determined that the second vehicle and the first vehicle interfere with each other, generate a traveling trajectory in which the first vehicle enters the circular intersection on the basis of an estimation result of an action of the second vehicle estimated by the action estimation unit.
(3): In the above aspect (1) or (2), the action estimation unit may determine whether a traveling trajectory of the second vehicle is classified as a linear traveling trajectory or classified as a curved traveling trajectory on the basis of a traveling trajectory for a predetermined time after the second vehicle enters the circular intersection, and estimates an action until the second vehicle will exit the circular intersection on the basis of the determination results.
(4): In any of the above aspects (1) to (3), the action estimation unit may collect representative points of the second vehicle at predetermined time intervals recognized by the recognition unit, and determine whether a traveling trajectory of the second vehicle is classified as a linear traveling trajectory or classified as a curved traveling trajectory on the basis of parameters when a shape model is applied to the traveling trajectory in which the collected representative points are connected.
(5): In any of the above aspects (1) to (4), the recognition unit recognizes an entrance that allows entry to and exit from the circular intersection, and when the traveling trajectory of the second vehicle is determined as a linear trajectory, the action estimation unit may estimate that the second vehicle will exit through an entrance closest to a current location of the second vehicle on an extension line in a traveling direction, and when the traveling trajectory of the second vehicle is determined as a curved trajectory, the action estimation unit may estimate that the second vehicle will not exit through an entrance closest to a current location of the second vehicle on an extension line in the traveling direction.
(6): In any of the above aspects (1) to (5), when the action estimation unit determines that the second vehicle moves along a curved trajectory, the trajectory generation unit may generate the traveling trajectory for the first vehicle to enter the circular intersection in order for the first vehicle to travel preferentially over the second vehicle, and when it is determined that the second vehicle moves along a linear trajectory, the trajectory generation unit may generate the traveling trajectory in which a timing at which the first vehicle enters the circular intersection is delayed in order for the second vehicle to travel preferentially over the first vehicle.
(7): In any of the above aspects (1) to (6), when the circular intersection recognized by the recognition unit has a shape that is able to be regarded as a circle and the radius of the outer edge of the circular intersection is constant, the action estimation unit may determine whether a traveling trajectory of the second vehicle is classified as a linear traveling trajectory or classified as a curved traveling trajectory on the basis of a difference between a curvature of the circular intersection and a curvature of the traveling trajectory.
(8): In any of the above aspects (1) to (7), the vehicle control device may further include a communication unit by which the first vehicle communicates with another vehicle, and when the recognition unit recognizes that a third vehicle is about to enter the circular intersection, the communication unit may transmit an estimation result of the second vehicle of the action estimation unit to the third vehicle that is about to enter the circular intersection.
(9): A vehicle control method according to an aspect of the present invention causing a computer to execute: recognizing, when the first vehicle enters a circular intersection, a traveling trajectory after the second vehicle that has entered the circular intersection enters the circular intersection; estimating an action until the second vehicle will exit the circular intersection; and generating, on the basis of the estimation result of the estimated action of the second vehicle, a traveling trajectory including a velocity component for the first vehicle to enter the circular intersection.
(10): A computer-readable non-transitory storage medium according to an aspect of the present invention in which a program is stored, causing a computer to execute: recognizing, when a first vehicle enters a circular intersection, a traveling trajectory after a second vehicle that has entered the circular intersection enters the circular intersection; estimating an action until the second vehicle will exit the circular intersection; and generating, on the basis of the estimation result of the estimated action of the second vehicle, a traveling trajectory including a velocity component for the first vehicle to enter the circular intersection.

According to the above aspects (1) to (10), it is possible to estimate an action of other vehicles that travel in a circular intersection.

### BRIEF DESCRIPTION OF THE DRAWINGS

FIG. 1 is a configuration diagram of a vehicle system using a vehicle control device according to a first embodiment.

FIG. 2 is a functional configuration diagram of a first control unit and a second control unit.

FIG. 3 is a diagram showing a first scenario.

FIG. 4 is a diagram for explaining a classification process performed by an action estimation unit.

FIG. 5 is a diagram for explaining a trajectory generating process of a trajectory generation unit.

FIG. 6 is a diagram showing a second scenario.

FIG. 7 is a diagram showing a third scenario.

FIG. 8 is a flowchart showing an example of a flow of a trajectory generating process of a first vehicle (host vehicle) performed by a vehicle system.

FIG. 9 is a diagram showing an example of a hardware configuration of a vehicle control device according to an embodiment.

### DETAILED DESCRIPTION OF THE INVENTION

Hereinafter, a vehicle control device, a vehicle control method, and a storage medium according to embodiments of the present invention will be described with reference to the drawings.

### Overall Configuration

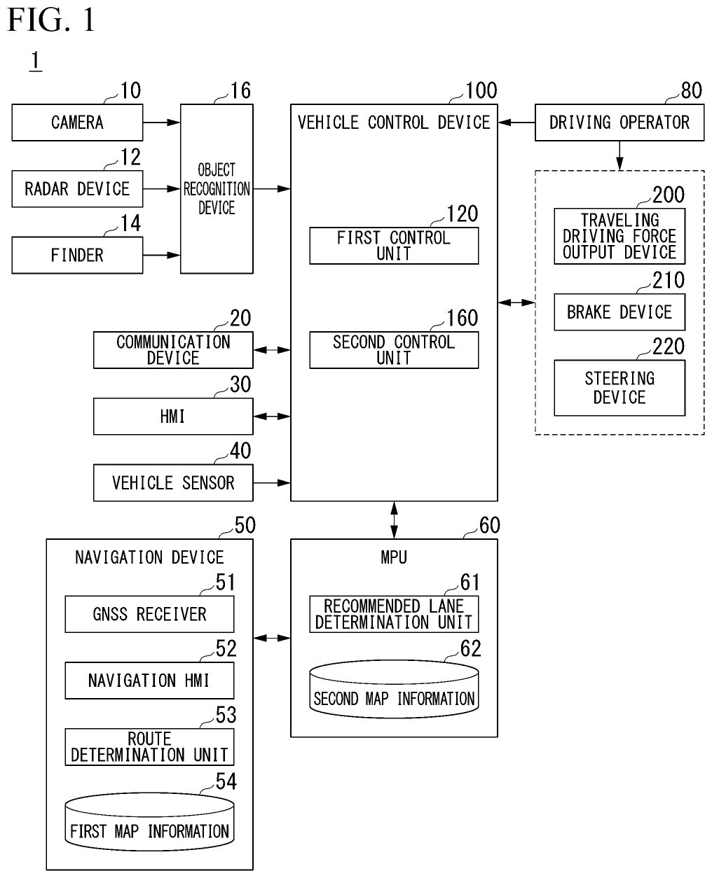

FIG. 1 is a configuration diagram of a vehicle system 1 using a vehicle control device 100 according to a first embodiment. A vehicle in which the vehicle system 1 is mounted is, for example, a vehicle with two wheels, three wheels, four wheels, or the like, and a driving source thereof includes an internal combustion engine such as a diesel engine and a gasoline engine, an electric motor, or a combination thereof. The electric motor operates using power generated by a power generator connected to the internal combustion engine or power discharged from a secondary battery or a fuel cell. In the following description, while it will be described that the vehicle system 1 can control and support traveling of a single vehicle, the vehicle system 1 can control and support traveling of a plurality of vehicles at the same time.

For example, the vehicle system 1 includes a camera 10, a radar device 12, a finder 14, an object recognition device 16, a driving operator 80, the vehicle control device 100, a traveling driving force output device 200, a brake device 210, and a steering device 220. These devices and instruments are connected to each other via a multiplex communication line such as a controller area network (CAN) communication line, a serial communication line, a wireless communication network, or the like. The configuration shown in FIG. 1 is only an example, and some of the components may be omitted or other components may be additionally added.

The camera 10 is, for example, a digital camera using a solid-state image sensor such as a charge coupled device (CCD) and a complementary metal oxide semiconductor (CMOS). The camera 10 is attached to an arbitrary part of the vehicle (hereinafter referred to as a host vehicle M) in which the vehicle system 1 is mounted. When the camera 10 captures an image in front of the vehicle, it is attached to an upper part of the front windshield, a rear surface of the rearview mirror, or the like. For example, the camera 10 images periodically and repeatedly the surroundings of the host vehicle M. The camera 10 may be a stereo camera. The host vehicle M is an example of a “first vehicle.”

The radar device 12 emits radio waves such as millimeter waves to the vicinity of the host vehicle M and detects radio waves (reflected waves) reflected at an object and detects at least a position (a distance and a direction) of the object. The radar device 12 is attached to an arbitrary part of the host vehicle M. The radar device 12 may detect a position and speed of the object according to a frequency modulated continuous wave (FM-CW) method.

The finder 14 uses light detection and ranging (LIDAR). The finder 14 emits light to the vicinity of the host vehicle M and measures scattered light. The finder 14 detects a distance to the object on the basis of a time from when light is emitted until light is received. Light which is emitted is, for example, a pulsed laser beam. The finder 14 is attached to an arbitrary part of the host vehicle M.

The object recognition device 16 performs sensor fusion processing on the detection results obtained by some or all of the camera 10, the radar device 12, and the finder 14 and recognizes a position, type, speed, and the like of the object. The object recognition device 16 outputs the recognition results to the vehicle control device 100. The object recognition device 16 may output the detection results of the camera 10, the radar device 12, and the finder 14 to the vehicle control device 100 without change. The object recognition device 16 may be omitted from the vehicle system 1.

A communication device 20 communicates with other vehicles present around the automated driving vehicle using, for example, a cellular network, a Wi-Fi network, Bluetooth (registered trademark), or dedicated short range communication (DSRC), or communicates with various server devices through a wireless base station. The communication device 20 is an example of a “communication unit.”

An HMI 30 presents various types of information to an occupant in the automated driving vehicle and receives an operation input by the occupant. The HMI 30 includes various display devices, a speaker, a buzzer, a touch panel, a switch, a key, and the like.

A vehicle sensor 40 includes a vehicle speed sensor that detects a speed of the automated driving vehicle, an acceleration sensor that detects an acceleration, a yaw rate sensor that detects an angular velocity around a vertical axis, a direction sensor that detects a direction of the automated driving vehicle, and the like.

A navigation device 50 includes, for example, a GNSS receiver 51, a navigation HMI 52, and a route determination unit 53. The navigation device 50 maintains first map information 54 in a storage device such as an HDD or a flash memory. The GNSS receiver 51 identifies a position of the automated driving vehicle on the basis of signals received from GNSS satellites. The position of the automated driving vehicle may be identified or supplemented by an inertial navigation system (INS) using an output of the vehicle sensor 40. The navigation HMI 52 includes a display device, a speaker, a touch panel, a key, and the like. A part of all of the navigation HMI 52 may be shared with the above HMI 30. For example, the route determination unit 53 determines a route to a destination input by the occupant using the navigation HMI 52 from the position (or any input position) of the automated driving vehicle identified by the GNSS receiver 51 (hereinafter referred to as a route on the map) with reference to the first map information 54. The first map information 54 is, for example, information in which a road pattern is expressed with links indicating roads and nodes connected by links. The first map information 54 may include a road curvature, point of interest (POI) information, and the like. The route on the map is output to an MPU 60. The navigation device 50 may perform route guidance using the navigation HMI 52 on the basis of the route on the map. The navigation device 50 may be realized by, for example, a function of a terminal device such as a smartphone and a tablet terminal that the occupant holds. The navigation device 50 may transmit the current position and destination to a navigation server through the communication device 20 and acquire the same route on the map from the navigation server.

The MPU 60 includes, for example, a recommended lane determination unit 61, and maintains second map information 62 in a storage device such as an HDD and a flash memory. The recommended lane determination unit 61 divides the route on the map provided from the navigation device 50 into a plurality of blocks (for example, divides every 100 [m] with respect to the traveling direction of the vehicle), and determines a recommended lane for each block with reference to the second map information 62. The recommended lane determination unit 61 determines in which lane numbered from the left to travel. When there is a branching point on the route on the map, the recommended lane determination unit 61 determines a recommended lane so that the automated driving vehicle can travel along a reasonable route to a branch destination.

The second map information 62 is map information with higher accuracy than the first map information 54. The second map information 62 includes, for example, information on the center of the lane, information on the boundary of the lane, and the like. The second map information 62 may include road information, traffic regulation information, address information (address and zip code), facility information, phone number information, and the like. The second map information 62 may be updated at any time according to communication by the communication device 20 with other devices.

The driving operator 80 includes, for example, an accelerator pedal, a brake pedal, a shift lever, a steering wheel, a variant steer, a joystick and other operators. A sensor that detects an operation amount or whether or not an operation has been performed is attached to the driving operator 80, and the detection result is output to the vehicle control device 100 or some or all of the traveling driving force output device 200, the brake device 210, and the steering device 220.

The vehicle control device 100 includes, for example, a first control unit 120 and a second control unit 160. For example, the first control unit 120 and the second control unit 160 each are realized when a hardware processor such as a CPU executes a program (software). Some or all of these components may be realized by hardware (circuit part; including a circuitry) such as an LSI, an ASIC, an FPGA, and a GPU, or may be realized in cooperation of software and hardware. The program may be stored in a storage device (a storage device including a non-transitory storage medium) in advance such as an HDD or a flash memory of the vehicle control device 100 or may be stored in a removable storage medium such as a DVD and a CD-ROM, and may be installed in an HDD or a flash memory in the vehicle control device 100 when the storage medium (non-transitory storage medium) is mounted in a drive device.

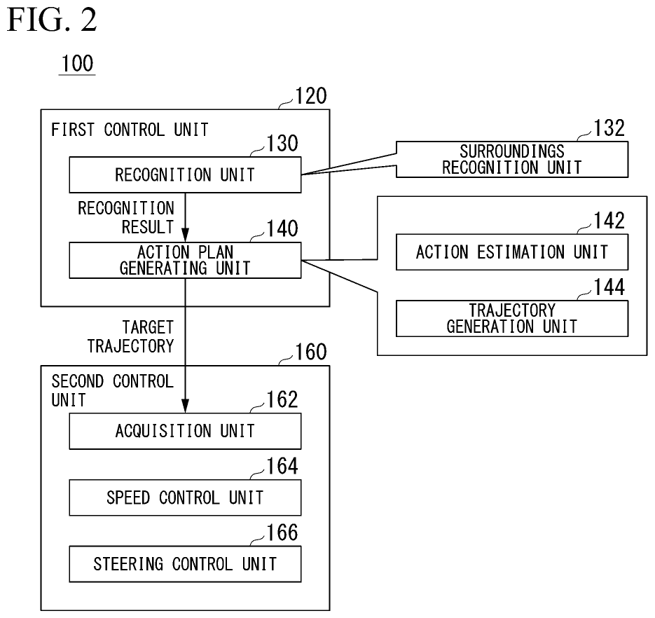

FIG. 2 is a functional configuration diagram of the first control unit 120 and the second control unit 160. The first control unit 120 includes, for example, a recognition unit 130 and an action plan generating unit 140. For example, the first control unit 120 realizes a function on the basis of artificial intelligence (AI) and a function on the basis of a model provided in advance in parallel. For example, a function of “recognizing an intersection” may be realized according to recognition of an intersection using deep learning and the like and recognition based on conditions provided in advance (pattern-matchable signals, road lanes and the like) executed in parallel, and scoring and comprehensively evaluating them. Thereby, the reliability of the automated driving is secured.

The recognition unit 130 recognizes the surroundings of the host vehicle M. The recognition unit 130 includes, for example, a surroundings recognition unit 132.

The surroundings recognition unit 132 recognizes the status of an object (including a preceding vehicle and an oncoming vehicle to be described below) around the automated driving vehicle such as a position, a speed, and an acceleration on the basis of information input from the camera 10, the radar device 12, and the finder 14 through the object recognition device 16. For example, the position of the object is recognized as a position on absolute coordinates using a representative point (center of rear wheel shaft, center of the drive shaft, center of gravity of the vehicle, or the like) of the automated driving vehicle as the origin and is used for control. The position of the object may be represented by a representative point such as the center of gravity or a corner of the object or may be represented by a representative region. The “status” of the object may include the acceleration or jerk of the object or “action status” (for example, whether it is changing or about to change lanes).

For example, the surroundings recognition unit 132 recognizes that a lane (host lane) in which the automated driving vehicle is traveling. For example, the surroundings recognition unit 132 compares a pattern of road lane lines (for example, an arrangement of solid lines and broken lines) obtained from the second map information 62 with a pattern of road lane lines around the automated driving vehicle recognized from the image captured by the camera 10, and thus recognizes the host lane. The surroundings recognition unit 132 may recognize the host lane by recognizing roadway boundaries (road boundaries) including road lane lines, shoulders, curbstones, median strips, and guardrails without limitation to road lane lines. In this recognition, the position of the automated driving vehicle acquired from the navigation device 50 and the processing result by INS may be taken into consideration. The surroundings recognition unit 132 recognizes temporary stop lines, obstacles, red lights, tollgates, and other road events.

When the host lane is recognized, the surroundings recognition unit 132 recognizes the position and direction of the automated driving vehicle with respect to the host lane. For example, the surroundings recognition unit 132 may recognize the deviation of a reference point on the automated driving vehicle with respect to the center of the lane and an angle formed with respect to the lane connected to the center of the lane in the traveling direction of the automated driving vehicle as the relative position and direction of the automated driving vehicle with respect to the host lane. Alternatively, the surroundings recognition unit 132 may recognize the position of the reference point on the automated driving vehicle with respect to any side end (road lane line or road boundary) of the host lane as the relative position of the automated driving vehicle with respect to the host lane.

The surroundings recognition unit 132 recognizes a nearby vehicle and particularly information about a road on which the host vehicle M is scheduled to travel on the basis of a vehicle near the host vehicle M recognized from the image captured by the camera 10, and the image captured by the camera 10, information about traffic jam around the host vehicle M acquired by the navigation device 50, and position information obtained from the second map information 62. The information about the road on which the vehicle is scheduled to travel includes, for example, a width of a lane (a width of a road) in which the host vehicle M is scheduled to travel.

The surroundings recognition unit 132 recognizes a circular intersection and an entrance that allows the vehicle to enter or exit the circular intersection. When the host vehicle M enters a circular intersection, the surroundings recognition unit 132 recognizes a traveling trajectory of another vehicle that has entered the circular intersection after it enters the circular intersection. The surroundings recognition unit 132 outputs the recognition result to the action plan generating unit 140.

The action plan generating unit 140 generates a target trajectory in which the host vehicle M will travel in the future such that the vehicle travels, in principle, in the recommended lane determined by the recommended lane determination unit 61, and additionally, is caused to automatically travel in order to respond the surrounding situation when the host vehicle M travels. The target trajectory includes, for example, a speed element. For example, the target trajectory is expressed as a sequence of points (trajectory points) that the host vehicle M should reach. The trajectory point is a point which the host vehicle M will reach for each of predetermined traveling distances (for example, about every tenths of a [m]) in the road distance, and separately from that, a target speed and a target acceleration are generated as a part of the target trajectory for each of predetermined sampling times (for example, about every several tenths of a [sec]). The action plan generating unit 140 may set an automated driving event when a target trajectory is generated. Examples of automated driving events include a constant-speed traveling event, a following traveling event, a lane change event, a branching event, a merging event, and a takeover event.

The action plan generating unit 140 includes, for example, an action estimation unit 142 and a trajectory generation unit 144.

The action estimation unit 142 estimates an action of another vehicle that has entered the circular intersection on the basis of the result recognized by the surroundings recognition unit 132. The trajectory generation unit 144 generates a traveling trajectory including a velocity component for the host vehicle M to enter the circular intersection on the basis of the estimation result of the action of the other vehicle estimated by the action estimation unit 142.

The second control unit 160 controls the traveling driving force output device 200, the brake device 210, and the steering device 220 so that the automated driving vehicle passes along the target trajectory generated by the action plan generating unit 140 according to a scheduled time.

Returning to FIG. 1, the second control unit 160 includes, for example, an acquisition unit 162, a speed control unit 164, and a steering control unit 166. The acquisition unit 162 acquires information on the target trajectory (trajectory point) generated from the action plan generating unit 140 and stores it in a memory (not shown). The speed control unit 164 controls the traveling driving force output device 200 or the brake device 210 on the basis of a speed element associated with the target trajectory stored in the memory. The steering control unit 166 controls the steering device 220 according to a degree of curvature of the target trajectory stored in the memory. The processing of the speed control unit 164 and the steering control unit 166 is realized by, for example, a combination of feedforward control and feedback control. As an example, the steering control unit 166 executes a combination of feedforward control according to the curvature of the road in front of the automated driving vehicle and feedback control based on a deviation from the target trajectory.

The traveling driving force output device 200 outputs a traveling driving force (torque) with which the vehicle travels to drive wheels. The traveling driving force output device 200 includes, for example, a combination of an internal combustion engine, an electric motor, and a transmission, and an ECU that controls them. The ECU controls the above configuration according to information input from the second control unit 160 or information input from the driving operator 80.

The brake device 210 includes, for example, a brake caliper, a cylinder that transmits a hydraulic pressure to a brake caliper, an electric motor that generates a hydraulic pressure in the cylinder, and a brake ECU. The brake ECU controls the electric motor according to information input from the second control unit 160 or information input from the driving operator 80, and outputs a brake torque according to the braking operation to wheels. The brake device 210 may include a mechanism that transmits a hydraulic pressure generated when the brake pedal included in the driving operator 80 is operated to the cylinder via a master cylinder as a backup. The brake device 210 is not limited to the above-described configuration, and may be an electronically controlled hydraulic brake device that controls an actuator according to information input from the second control unit 160 and transmits a hydraulic pressure of the master cylinder to the cylinder.

The steering device 220 includes, for example, a steering ECU and an electric motor. For example, the electric motor applies a force to a rack and pinion mechanism and changes the direction of steered wheels. The steering ECU drives the electric motor according to the information input from the second control unit 160 or the information input from the driving operator 80 and changes the direction of steered wheels.

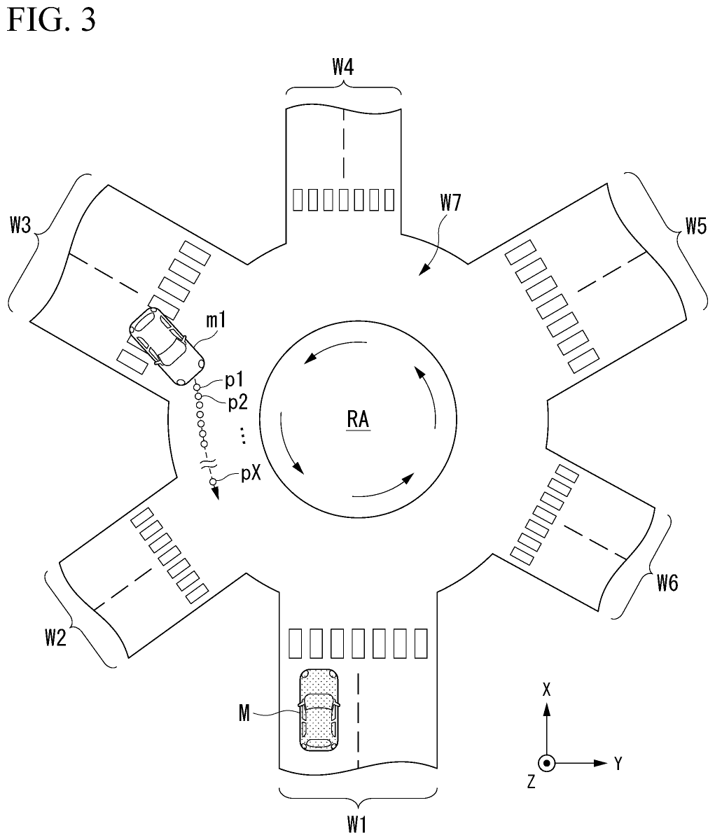

FIG. 3 is a diagram showing a first scenario. The first scenario is a scenario in which the host vehicle M travels along a road W1 along which it enters a circular intersection RA and approaches the circular intersection RA. In the first scenario, before the host vehicle M enters the circular intersection RA, another vehicle m1 enters the circular intersection RA from another road W3. In FIG. 3, the circular intersection RA is an intersection in which six roads W1 to W6 are connected to each other via a one-way circular road (annular road) W7. In principle, in the circular road W7, no traffic signals are installed, and there is no temporarily obligation to stop when the vehicle enters. For example, the vehicle can enter and exit the circular intersection RA through any road of the roads W1 to W6. Each vehicle that uses the circular intersection RA passes the circular road W7 counterclockwise. As shown, pedestrian crossings may be provided on the roads W1 to W6.

For example, as illustrated, when the host vehicle M travels along the road W1 connected to the circular intersection RA in an X-axis direction, approaches the circular intersection RA, and is about to enter the circular intersection RA, the surroundings recognition unit 132 recognizes another vehicle that travels in the circular intersection RA and another vehicle that is about to enter the circular intersection RA. When the host vehicle M is about to enter the circular intersection RA, the surroundings recognition unit 132 recognizes a traveling trajectory after the other vehicle m1 (an example of a “second vehicle”) that has entered the circular road W7 of the circular intersection RA from the other road W3 connected to the circular intersection RA enters the circular intersection RA.

The action estimation unit 142 estimates an action of the other vehicle m1 on the basis of the recognition result of the other vehicle m1 by the surroundings recognition unit 132. For example, the action estimation unit 142 estimates an action regarding whether the other vehicle m1 is about to exit the circular intersection RA from the road W1 or continues to travel along the circular road W7 and is about to exit the other road W6 connected to the circular intersection RA on the basis of the result recognized by the surroundings recognition unit 132 for a predetermined time (for example, about several [sec]) after the other vehicle m1 enters the circular intersection RA.

The action estimation unit 142 collects representative points p1 to pX (X is a natural number) of the other vehicle m1 recognized by the surroundings recognition unit 132 at predetermined time intervals. The action estimation unit 142 determines whether the traveling trajectory of the other vehicle m1 is classified as a linear traveling trajectory or a curved traveling trajectory on the basis of parameters when a shape model is applied to the traveling trajectory of the other vehicle m1 derived by connecting the collected representative points p1 to pX. The shape model is, for example, an arc model, and the parameter is, for example, a curvature. This will be assumed in the following description. The action estimation unit 142 may perform classification on the basis of the radius of the curvature in place of the curvature. When a shape model other than the arc model (for example, a polynomial function) is applied, the action estimation unit 142 performs classification on the basis of parameters other than the curvature and the radius of the curvature (a coefficient, and the like).

### Classification Process

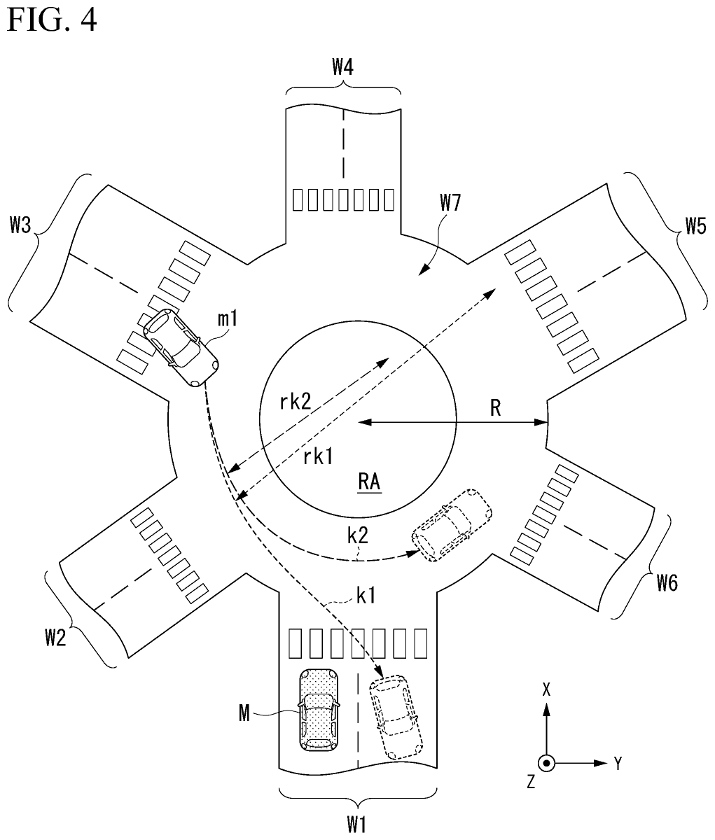

FIG. 4 is a diagram for explaining a classification process performed by the action estimation unit 142. For example, the action estimation unit 142 determines whether the traveling trajectory of the other vehicle m1 is classified as a linear traveling trajectory k1 or classified as a curved traveling trajectory k2 on the basis of the traveling trajectory of the other vehicle m1 for a predetermined time recognized by the surroundings recognition unit 132, and estimates an action until the other vehicle m1 will exit the circular intersection on the basis of the determination results. The traveling trajectory k1 is a traveling trajectory when the other vehicle m1 exits the circular intersection RA to the road W1 which is the next entrance. The traveling trajectory k2 is a traveling trajectory when the other vehicle m1 continues to travel along the circular road W7 of the circular intersection RA.

The action estimation unit 142 performs fitting processing of the arc model on the traveling trajectory of the other vehicle m1 derived by connecting the representative points p1 to pX while changing the curvature, and for example, searches for an arc in which a sum of squares of the shortest distances between the sampling points set at equal intervals and the traveling trajectory is minimized in the arc model. Then, the curvature of the arc obtained as a result of the search is set as an approximate curvature of the traveling trajectory. When the circular intersection RA recognized by the surroundings recognition unit 132 has a shape that can be regarded as a circle and the radius R of the outer edge of the circular intersection RA is constant, a distance rk1 from the center of the circular intersection RA to an arbitrary part of the traveling trajectory k1 (for example, the estimated position of the other vehicle m1 after a predetermined time) is estimated. For example, the action estimation unit 142 determines that the traveling trajectory of the other vehicle m1 is classified as a linear traveling trajectory on the basis of a difference between the curvature 1/R of the circular intersection RA and the curvature 1/rk1 of the traveling trajectory k1. When the surroundings recognition unit 132 recognizes the entrance that allows the vehicle to enter and exit the circular intersection RA and the curvature of the traveling trajectory of the other vehicle m1 is 1/rk1 and the traveling trajectory of the other vehicle m1 is determined as a linear traveling trajectory k1, the action estimation unit 142 estimates that the other vehicle m1 will exit to the road W1 which is the closest entrance on the extension line in the traveling direction from the current location of the other vehicle m1 and travel along the road W1. For example, when the distance rk1 of the traveling trajectory is equal to or larger than a value obtained by multiplying the radius R of the circular intersection RA by an arbitrary coefficient, that is, when the curvature 1/rk1 of the traveling trajectory is less than a value obtained by multiplying the radius R of the circular intersection RA by a predetermined coefficient, the action estimation unit 142 estimates that the traveling trajectory of the other vehicle m1 will be the traveling trajectory k1 classified as a linear traveling trajectory.

When the circular intersection RA recognized by the surroundings recognition unit 132 has a shape that can be regarded as a circle and the radius R of the outer edge of the circular intersection RA is constant, the action estimation unit 142 estimates a distance rk2 from the center of the circular intersection RA to an arbitrary part of the traveling trajectory k2. For example, the action estimation unit 142 determines that the traveling trajectory of the other vehicle m1 is classified as a curved traveling trajectory on the basis of a difference between the curvature 1/R of the circular intersection RA and the curvature 1/rk2 of the traveling trajectory k2.

When the curvature of the traveling trajectory of the other vehicle m1 is 1/rk2 and the traveling trajectory of the other vehicle m1 is determined as the curved the traveling trajectory k2, the action estimation unit 142 estimates that the other vehicle m1 will not exit through the closest entrance on the extension line in the traveling direction from the current location of the other vehicle m1, that is, will not travel along the road W1, and will continue to travel along the circular road W7. For example, when the distance rk2 of the traveling trajectory is less than a value obtained by multiplying the radius R of the circular intersection RA by an arbitrary coefficient, that is, when the curvature 1/rk2 of the traveling trajectory is equal to or larger than a value obtained by multiplying the radius R of the circular intersection RA by a predetermined coefficient, the action estimation unit 142 estimates that the traveling trajectory of the other vehicle m1 is the traveling trajectory k2 classified as a curved traveling trajectory.

The action estimation unit 142 may determine whether the traveling trajectory of the other vehicle m1 is classified as a linear traveling trajectory or classified as a curved traveling trajectory on the basis of the amount of change in the curvature of the traveling trajectory of the other vehicle m1 at predetermined time intervals. For example, when the amount of change in the curvature of the traveling trajectory of the other vehicle m1 at predetermined time intervals is smaller than a reference value, the action estimation unit 142 determines that the traveling trajectory of the other vehicle m1 is classified as a curved traveling trajectory, and when the amount of change in the curvature of the traveling trajectory of the other vehicle m1 at predetermined time intervals is larger than a reference value, the action estimation unit 142 determines that the traveling trajectory of the other vehicle m1 is classified as a linear traveling trajectory.

The action estimation unit 142 may apply the result recognized by the surroundings recognition unit 132 regarding whether the direction indicator (turn signal lamp) of the other vehicle m1 is turned on to a determination element for estimating the action of the other vehicle m1.

### Trajectory Generating Process

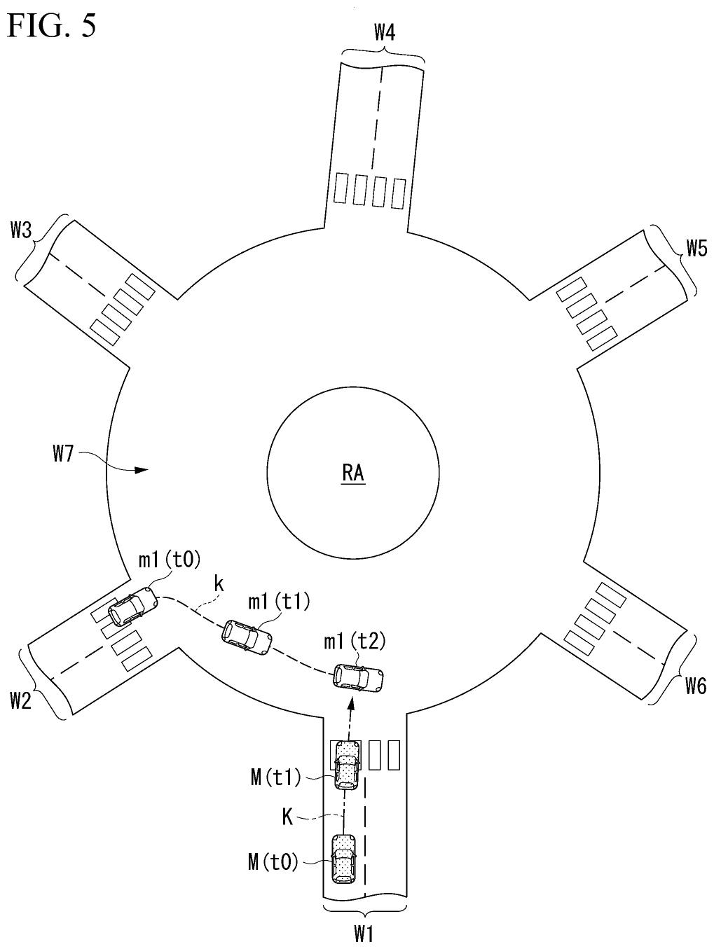

FIG. 5 is a diagram for explaining a trajectory generating process performed by the trajectory generation unit 144. When the surroundings recognition unit 132 recognizes the other vehicle m1 that has entered the circular intersection RA from the road W2, the trajectory generation unit 144 refers to the estimation result of the action estimation unit 142 and determines whether the other vehicle m1 and the host vehicle M will interfere with each other. When it is determined that the other vehicle m1 and the host vehicle M will interfere with each other, the trajectory generation unit 144 generates a traveling trajectory K along which the host vehicle M can enter the circular intersection RA without interfering with the other vehicle m1 (reducing the likelihood of interference) on the basis of the estimation result of the action of the other vehicle m1 estimated by the action estimation unit 142. When the trajectory generation unit 144 refers to the estimation result of the action estimation unit 142 and determines whether the other vehicle m1 and the host vehicle M will interfere with each other, and it is determined that the other vehicle m1 and the host vehicle M will not interfere with each other, the trajectory generation unit 144 generates a raveling trajectory K along which the host vehicle M enters the circular intersection RA. When the trajectory generation unit 144 determines that the other vehicle m1 and the host vehicle M will not interfere with each other, the trajectory generation unit 144 may generate a trajectory without referring to the estimation result of the other vehicle m1 of the action estimation unit 142 in the trajectory generation.

In the following description, a time when the other vehicle m1 that has entered the circular intersection RA from the road W2 is recognized by the surroundings recognition unit 132 is referred to as a time t0. The action estimation unit 142, for example, on the basis of the recognition result of the other vehicle m1 from the time t0 at which it is recognized by the surroundings recognition unit 132 to a time t1 after a certain time has elapsed from the time t0, recognizes a traveling trajectory k of the other vehicle m1, and recognizes a distance rk between the traveling trajectory k and the center position of a circle when the circular intersection RA is regarded as having a circular shape, and thus estimates a position of the other vehicle m1 at a time t2 after a certain time has elapsed from the time t1. The trajectory generation unit 144 generates a traveling trajectory K of the host vehicle M on the basis of the estimation result of the action estimation unit 142.

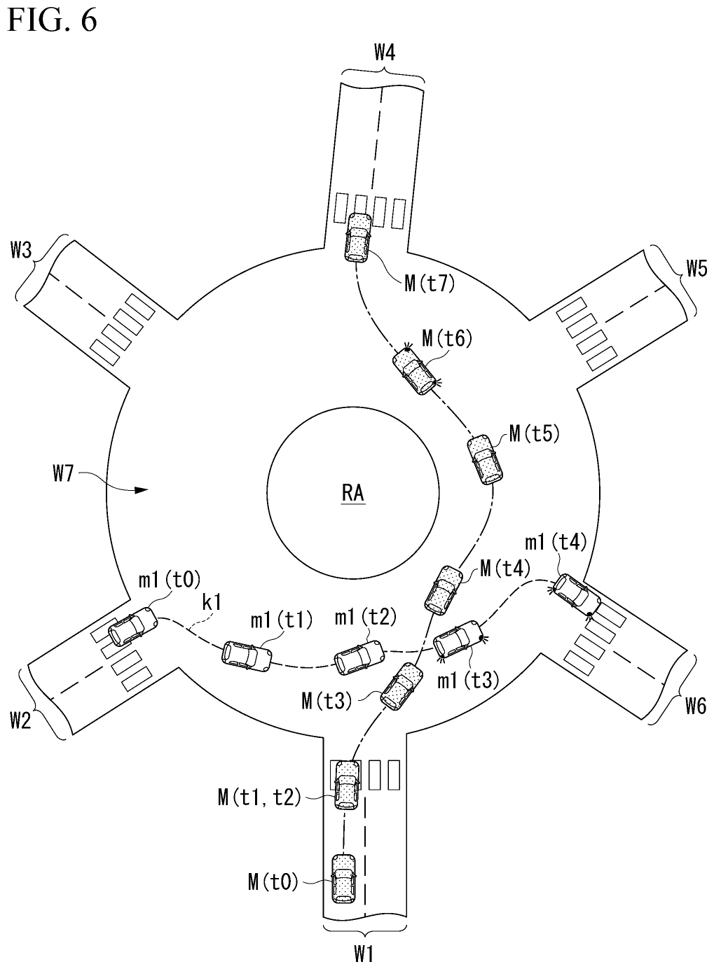

FIG. 6 is a diagram showing a second scenario. The second scenario is a scenario in which, when the traveling trajectory k1 of the other vehicle m1 that enters the circular road W7 from the road W2 is classified as a linear traveling trajectory, in order for the other vehicle m1 to travel preferentially over the host vehicle M, a timing at which the host vehicle M enters the circular intersection RA is delayed. In FIG. 6 and thereafter, the host vehicle M at the time t is denoted as M(t), and the other vehicle m1 at the time t is denoted as m1(t).

When the action estimation unit 142 determines that the traveling trajectory k1 of the other vehicle m1 is classified as a linear traveling trajectory, in order for the other vehicle m1 to travel preferentially over the host vehicle M, the trajectory generation unit 144 generates a traveling trajectory in which a timing at which the host vehicle M enters the circular intersection RA is delayed. Allowing the other vehicle m1 to travel preferentially over the host vehicle M includes a case in which the host vehicle M is caused to decelerate or stop in order to prevent the other vehicle m1 and the host vehicle M from interfering with each other. Allowing the other vehicle m1 to travel preferentially over the host vehicle M includes a case in which the host vehicle M is caused to cut in at a location behind the other vehicle m1 in the traveling direction. In this manner, the other vehicle m1 is allowed to travel preferentially over the host vehicle M because in this case it is possible to reduce the likelihood of the traveling trajectory k1 of the other vehicle m1 and the traveling trajectory K of the host vehicle M crossing in a similar time period and the likelihood of the other vehicle m1 reaching the traveling trajectory K of the host vehicle M in a relatively short time because the other vehicle m1 travels linearly, and it is possible to reduce a possibility of the other vehicle m1 and the host vehicle M interfering with each other.

For example, when the other vehicle m1 enters the circular intersection RA from the road W2 and exits the road W6, the action estimation unit 142 determines whether the host vehicle M and the other vehicle m1 which are traveling along the road W1 interfere with each other on the basis of the recognition result of the surroundings recognition unit 132 from the time t0 to the time t1. When the action estimation unit 142 determines that the host vehicle M and the other vehicle m1 which are travelling along the road W1 interfere with each other, the trajectory generation unit 144 generates a traveling trajectory K in which the host vehicle M can enter the circular intersection RA without interfering with the other vehicle m1 and the host vehicle M can exit the road W4 which is a desired exit. For example, the trajectory generation unit 144 generates a traveling trajectory K in which the host vehicle M is caused to temporarily stop from the time t1 to the time t2, the other vehicle m1 is allowed to travel preferentially, and then the host vehicle M is caused to enter the circular intersection RA, and enter the road W4 at the time t7 and exit the circular intersection RA.

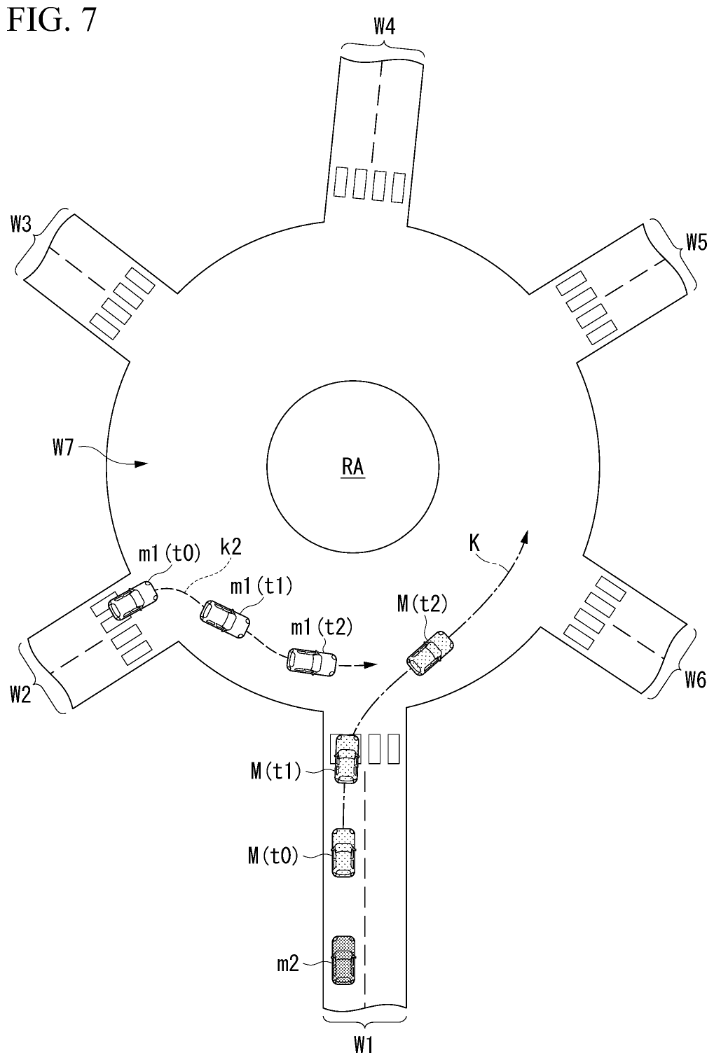

FIG. 7 is a diagram showing a third scenario. The third scenario is a scenario in which, when the traveling trajectory k2 of the other vehicle m1 that enters the circular road W7 from the road W2 is classified as a curved traveling trajectory, the host vehicle M is caused to travel preferentially over the other vehicle m1. In the third scenario, a vehicle m2 other than the host vehicle M and the other vehicle m1 is present behind the host vehicle M on the road W1 in traveling direction.

When the action estimation unit 142 determines that the traveling trajectory k2 of the other vehicle m1 is classified as a curved traveling trajectory, the trajectory generation unit 144 generates a traveling trajectory in which the host vehicle M enters the circular intersection RA in order for the host vehicle M to travel preferentially over the other vehicle m1. Allowing the host vehicle M to travel preferentially over the other vehicle m1 includes a case in which the host vehicle M is caused to accelerate or decelerate to enter the circular road W7. Allowing the host vehicle M to travel preferentially over the other vehicle m1 includes a case in which the host vehicle M is caused to cut a location in front of the other vehicle m1 in the traveling direction. In this manner, when the traveling trajectory of the other vehicle m1 and the traveling trajectory of the host vehicle Mm are similar, the host vehicle M is caused to travel preferentially over the other vehicle m1. This is because, since it is estimated that it will take some time for the other vehicle m1 to reach the traveling trajectory in the circular road W7 of the host vehicle M, if the host vehicle M is caused to travel ahead of the other vehicle m1 in the circular road W7 in the traveling direction, a more suitable traffic flow is expected.

For example, when the other vehicle m1 enters the circular intersection RA from the road W2 and continues to travel along the circular road W7, the action estimation unit 142 determines whether the host vehicle M and the other vehicle m1 which travel along the road W1 will interfere with each other on the basis of the recognition result of the surroundings recognition unit 132 from the time t0 to the time t1. When the action estimation unit 142 determines that the host vehicle M and the other vehicle m1 which travel along the road W1 interfere with each other, the trajectory generation unit 144 generates a traveling trajectory K in which the host vehicle M can enter the circular intersection RA without interfering with the other vehicle m1. For example, the trajectory generation unit 144 generates a traveling trajectory K in which the host vehicle M is caused to accelerate from the time t1 to the time t2 and the host vehicle M is caused to travel preferentially.

The communication device 20 transmits these estimation results of the action estimation unit 142 to the other vehicle m2. Thereby, for example, when the other vehicle m2 travels according to a following traveling event in which it follows the host vehicle M, the vehicle control device 100 of the other vehicle m2 can recognize in advance before entering the circular intersection RA whether the other vehicle m2 will continue the following traveling event even after the host vehicle M enters the circular intersection RA and whether it is necessary to stop the following traveling event and generate a traveling trajectory by its own vehicle control device 100, and it is possible to create a more suitable travel plan.

### Process Flow

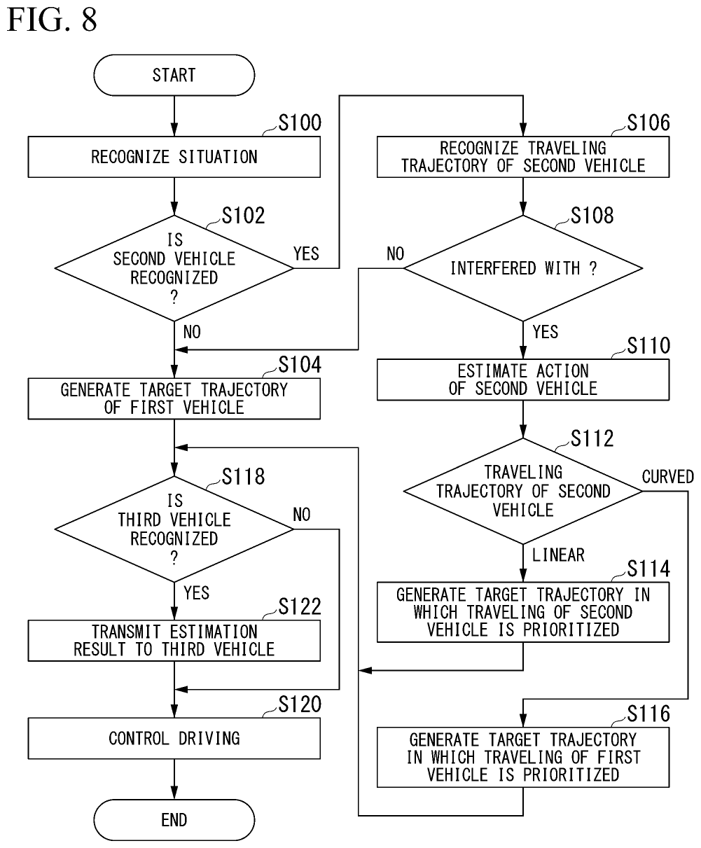

FIG. 8 is a flowchart showing an example of a flow of a trajectory generating process of the first vehicle (the host vehicle M) performed by the vehicle system 1. For example, the process of the flowchart shown in FIG. 8 starts when the first vehicle (the host vehicle M) approaches the circular intersection RA.

First, the surroundings recognition unit 132 recognizes a situation around the first vehicle (the host vehicle M) (Step S100). Next, the surroundings recognition unit 132 determines whether the other vehicle m1 that satisfies conditions for the second vehicle in Step S100 has been recognized (Step S102). When the other vehicle m1 that satisfies conditions for the second vehicle has not been recognized, the trajectory generation unit 144 generates a target trajectory of the first vehicle (the host vehicle M) (Step S104).

When the other vehicle m1 that satisfies conditions for the second vehicle has been recognized in Step S102, the surroundings recognition unit 132 recognizes the traveling trajectory k after the other vehicle m1 enters the circular intersection RA (Step S106). Next, the action estimation unit 142 determines whether the second vehicle will interfere with the first vehicle (Step S108). When it is determined that the second vehicle does not interfere with the first vehicle, the trajectory generation unit 144 advances the process to Step S104. When it is determined that the second vehicle interferes with the first vehicle, the action estimation unit 142 estimates an action of the second vehicle (Step S110). Next, the action estimation unit 142 determines whether the traveling trajectory of the second vehicle is classified as a linear traveling trajectory or classified as a curved traveling trajectory on the basis of the result of the process of Step S110 (Step S112).

In Step S112, when it is determined that the traveling trajectory of the second vehicle is classified as a linear traveling trajectory, the trajectory generation unit 144 generates a target trajectory in which traveling of the second vehicle is prioritized (Step S114). In Step S112, when it is determined that the traveling trajectory of the second vehicle is classified as a curved traveling trajectory, the trajectory generation unit 144 generates a target trajectory in which traveling of the first vehicle is prioritized (Step S116).

After the process of any of Step S104, Step S114, and Step S116, the surroundings recognition unit 132 determines whether a third vehicle positioned in the traveling direction of the first vehicle has been recognized (Step S118). When the third vehicle has not been recognized, the second control unit 160 controls the traveling driving force output device 200, the brake device 210, and the steering device 220 so that the target trajectory generated by the trajectory generation unit 144 passes the automated driving vehicle according to a scheduled time (Step S120). When the third vehicle has been recognized, the communication device 20 transmits the estimation result of the action estimation unit 142 to the third vehicle (Step S122), and the process advances to Step S120. As above, description of the process of this flowchart is completed.

As described above, according to the present embodiment, when the host vehicle M which is the first vehicle enters the circular intersection RA, the surroundings recognition unit 132 recognizes a traveling trajectory after the other vehicle m1 as the second vehicle that has entered the circular intersection enters the circular intersection RA, the action estimation unit 142 estimates an action until the other vehicle m1 as the second vehicle will exit the circular intersection RA, the trajectory generation unit 144 generates a traveling trajectory K including a velocity component for the host vehicle M as the first vehicle to enter the circular intersection RA on the basis of the estimation result of the action of the other vehicle m1 as the second vehicle estimated by the action estimation unit 142, and thus the action of the other vehicle m1 which travels in the circular intersection RA can be estimated. According to the present embodiment, on the basis of the estimation result of the action of the other vehicle m1 which travels in the circular intersection RA obtained by the action estimation unit 142, the trajectory generation unit 144 generates the target trajectory of the host vehicle M, and thus the host vehicle M can travel in the circular intersection RA smoothly and autonomously.

### Hardware Configuration

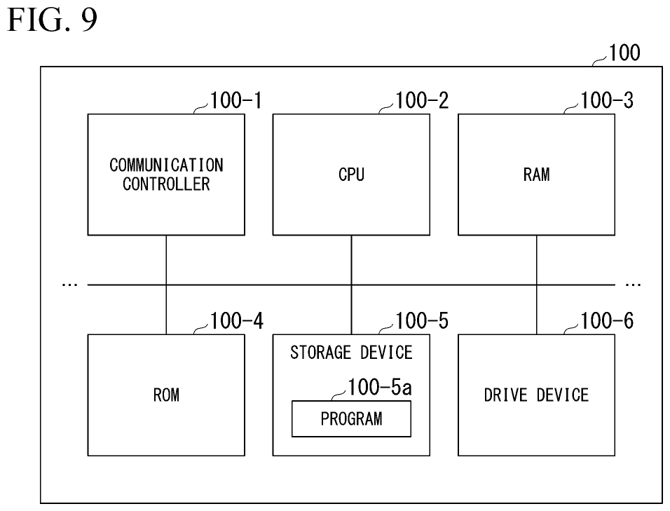

FIG. 9 is a diagram showing an example of a hardware configuration of the vehicle control device 100 according to the embodiment. As illustrated, the vehicle control device 100 has a configuration including a communication controller 100-1, a CPU 100-2, a RAM 100-3 used as a working memory, a ROM 100-4 in which a boot program and the like are stored, a storage device 100-5 such as a flash memory and a HDD, a drive device 100-6 and the like which are connected to each other via an internal bus or a dedicated communication line. The communication controller 100-1 communicates with components other than the vehicle control device 100. In the storage device 100-5, a program 100-5a that the CPU 100-2 executes is stored. This program is loaded into the RAM 100-3 by a direct memory access (DMA) controller (not shown) or the like and executed by the CPU 100-2. Thereby, some or all of the first control unit 120 and the second control unit 160 are realized.

The embodiment described above can be expressed as follows.

A vehicle control device has a configuration including

a storage device in which a program is stored; and

a hardware processor,

wherein the hardware processor causes the program stored in the storage device to execute:

recognizing, when the first vehicle enters a circular intersection, a traveling trajectory after the second vehicle that has entered the circular intersection enters the circular intersection;

estimating an action until the second vehicle exits the circular intersection; and

generating, on the basis of the estimation result of the estimated action of the second vehicle, a traveling trajectory including a velocity component for the first vehicle to enter the circular intersection.

While forms for implementing the present invention have been described above with reference to embodiments, the present invention is not limited to the embodiments at all, and various modifications and substitutions can be made without departing from the spirit and scope of the present invention.

For example, when the vehicle system 1 can control and support traveling of a plurality of vehicles at the same time, if the surroundings recognition unit 132 recognizes the presence of the first vehicle that approaches the circular intersection RA, it may determine whether the second vehicle that is about to enter the circular intersection RA is recognized and recognize a traveling trajectory of the second vehicle on the basis of an imaging result of the camera 10 installed in the vehicle or an imaging result of a camera provided at an arbitrary position (for example, near a street lamp at which the circular intersection RA can be observed from a bird's eye view) of the circular intersection RA.

What is claimed is:

1. A vehicle control device, comprising:
a recognition unit configured to, when a first vehicle enters a circular intersection, recognize a traveling trajectory after a second vehicle that has entered the circular intersection enters the circular intersection;
an action estimation unit configured to estimate an action until the second vehicle exits the circular intersection; and
a trajectory generation unit configured to generate a traveling trajectory including a velocity component for the first vehicle to enter the circular intersection on the basis of an estimation result of an action of the second vehicle estimated by the action estimation unit.

2. The vehicle control device according to claim 1,
wherein the trajectory generation unit refers to an estimation result of the action estimation unit and determines whether the second vehicle and the first vehicle interfere with each other, and when it is determined that the second vehicle and the first vehicle interfere with each other, generates a traveling trajectory in which the first vehicle enters the circular intersection on the basis of an estimation result of an action of the second vehicle estimated by the action estimation unit.

3. The vehicle control device according to claim 1,
wherein the action estimation unit determines whether a traveling trajectory of the second vehicle is classified as a linear traveling trajectory or classified as a curved traveling trajectory on the basis of a traveling trajectory for a predetermined time after the second vehicle enters the circular intersection, and estimates an action until the second vehicle exits the circular intersection on the basis of the determination results.

4. The vehicle control device according to claim 1,
wherein the action estimation unit collects representative points of the second vehicle at predetermined time intervals recognized by the recognition unit, and determines whether a traveling trajectory of the second vehicle is classified as a linear traveling trajectory or classified as a curved traveling trajectory on the basis of parameters when a shape model is applied to the traveling trajectory in which the collected representative points are connected.

5. The vehicle control device according to claim 1,
wherein the recognition unit recognizes an entrance that allows entry to and exit from the circular intersection, and
wherein, when it is determined that the traveling trajectory of the second vehicle is classified as a linear traveling trajectory, the action estimation unit estimates that the second vehicle will exit through an entrance closest to a current location of the second vehicle on an extension line in a traveling direction, and
when it is determined that the traveling trajectory of the second vehicle is classified as a curved traveling trajectory, the action estimation unit estimates that the second vehicle will not exit through an entrance closest to a current location of the second vehicle on an extension line in the traveling direction.

6. The vehicle control device according to claim 1,
wherein, when the action estimation unit determines that a traveling trajectory of the second vehicle is classified as a curved traveling trajectory, the trajectory generation unit generates the traveling trajectory for the first vehicle to enter the circular intersection in order for the first vehicle to travel preferentially over the second vehicle, and
when it is determined that a traveling trajectory of the second vehicle is classified as a linear traveling trajectory, the trajectory generation unit generates the traveling trajectory in which a timing at which the first vehicle enters the circular intersection is delayed in order for the second vehicle to travel preferentially over the first vehicle.

7. The vehicle control device according to claim 1,
wherein, when the circular intersection recognized by the recognition unit has a shape that is able to be regarded as a circle and the radius of the outer edge of the circular intersection is constant, the action estimation unit determines whether a traveling trajectory of the second vehicle is classified as a linear traveling trajectory or classified as a curved traveling trajectory on the basis of a difference between a curvature of the circular intersection and a curvature of the traveling trajectory.

8. The vehicle control device according to claim 1, further comprising
a communication unit by which the first vehicle communicates with another vehicle,
wherein, when the recognition unit recognizes that a third vehicle is about to enter the circular intersection, the communication unit transmits an estimation result of the second vehicle of the action estimation unit to the third vehicle that is about to enter the circular intersection.

9. A vehicle control method causing a computer to execute:
recognizing, when the first vehicle enters a circular intersection, a traveling trajectory after the second vehicle that has entered the circular intersection enters the circular intersection;
estimating an action until the second vehicle exits the circular intersection; and
generating, on the basis of the estimation result of the estimated action of the second vehicle, a traveling trajectory including a velocity component for the first vehicle to enter the circular intersection.

10. A computer-readable non-transitory storage medium in which a program is stored, causing a computer to execute:
recognizing, when a first vehicle enters a circular intersection, a traveling trajectory after a second vehicle that has entered the circular intersection enters the circular intersection;
estimating an action until the second vehicle exits the circular intersection; and generating, on the basis of the estimation result of the estimated action of the second vehicle, a traveling trajectory including a velocity component for the first vehicle to enter the circular intersection.
